(19) United States
(12) Patent Application Publication
(10) Pub. No.: US 2026/0167348 A1
(43) Pub. Date: Jun. 18, 2026

(54) DETERMININIG A TAKE-OFF AND LANDING PARAMETER OF AN AIRCRAFT

(71) Applicant: Honeywell International Inc., Charlotte, NC (US)

(72) Inventors: Ari Narayanan Mayandi, Madurai (IN); Kirupakar J, Phoenix, AZ (US); Saravana Venkatesh Narayanasamy, Madurai (IN); Srihari Jayathirtha, Peoria, AZ (US); Saurabh Jindal, Phoenix, AZ (US); Kalimulla Khan, Bangalore (IN)

(21) Appl. No.: 19/093,304

(22) Filed: Mar. 28, 2025

(30) Foreign Application Priority Data
Dec. 12, 2024 (IN) 202411098451

(51) Int. Cl. B64D 45/00; B64C 25/42; G08G 5/26

(52) U.S. Cl. CPC B64D 45/0005; B64C 25/426; G08G 5/26; B64D 2045/0085

(57) ABSTRACT

Example approaches for determining take-off and landing (TOLD) parameters for an aircraft are disclosed. In an example, a flight status specifying a flight stage of an aircraft is obtained and configuration data including flight-specific details corresponding to the flight stage is retrieved from data sources. The configuration data is then segmented into data fields to extract values of flight specific parameters representing operational conditions. A TOLD parameter is determined based on the flight specific parameters, using either predefined set of rules or a trained machine learning model. Thereafter, the flight specific parameters are displayed on a display device for pilot confirmation or modification before determining TOLD parameters. The determined TOLD parameters are rendered on a display device for pilot viewing. In an example, the TOLD parameters may be analyzed against historical data to provide aircraft configuration suggestions for effecting guided control of the aircraft.

### BACKGROUND

Aircraft operations, particularly during take-off and landing phases, involve complex calculations and adherence to specific parameters to ensure safety and efficiency. These calculations, known as Take-off and Landing Data (TOLD), are used to determine factors such as required runway length, aircraft speed, and weight limitations. TOLD calculations typically incorporate various data points, including but not limited to, atmospheric conditions, runway characteristics, aircraft configuration, and operational constraints.

### BRIEF DESCRIPTION OF FIGURES

Systems and/or methods, in accordance with examples of the present subject matter are now described and with reference to the accompanying figures, in which:

FIG. 1 illustrates a computing system for determining a take-off and landing parameter of an aircraft, as per an example;

FIG. 2 illustrates an aircraft communication environment comprising a take-off and landing (TOLD) computation system, as per an example;

FIG. 3 illustrates a TOLD computation system in communication with various data sources, as per an example;

FIG. 4 illustrates a TOLD computation system for determining a TOLD parameter, as per an example;

FIG. 5 illustrates a computing system for training a TOLD computation model, as per another example;

FIG. 6 illustrates a method, performed by a ground station, for determining a TOLD parameter, as per an example;

FIG. 7 illustrates a method, performed by an aircraft, for determining a TOLD parameter, as per an example;

FIG. 8 illustrates a detailed method, performed by a ground station, to determine a TOLD parameter, as per another example;

FIG. 9 illustrates a method for determining a TOLD parameter using a TOLD computation model, as per an example; and

FIG. 10 illustrates a system environment implementing a non-transitory computer readable medium for determining a TOLD parameter using a TOLD computation model, as per an example.

### DETAILED DESCRIPTION

During its journey from a originating location to a destination, an aircraft maneuvers through various stages ranging from pre-flight preparation, taxiing, climb, cruise, descent, approach, landing, and post-flight procedures. Each of these stages requires precise planning, execution, and monitoring of parameters to ensure safe and efficient flight operations. While all stages are important, the take-off and landing stages are particularly important, demanding precise calculations and strict adherence to specific parameters due to their inherent risks and complexities posed not only due to the operation of the aircraft but also owing to influence of external parameters, such as the environment. These parameters, which are referred to as Take-off and Landing Data (TOLD), involves determining factors such as required runway length, aircraft speed, and weight limitations. TOLD computation typically incorporate various data points, including but not limited to, atmospheric conditions, runway characteristics, aircraft configuration, and operational constraints.

Conventionally, pilots have been responsible for manually inputting data and calculating the TOLD parameters based on information received from multiple sources. This process may involve gathering data from various systems and sources, such as weather reports, airport information databases, and sensors onboard the aircraft. The manual nature of this task may introduce scope for human error and may result in significant safety implications in aviation. As aircraft technology advances and operational requirements become more complex, the complexities of TOLD computation has increased. Pilots may need to consider numerous variables from diverse sources and account for last-minute changes as well, such as runway reassignments or updated weather information, for computing TOLD parameter. The time pressure associated with these situations may further increase the challenge of performing accurate calculations manually.

Approaches for determining a take-off and landing (TOLD) parameter of an aircraft are described. The determination of TOLD parameter, in an example, may be used to optimize aircraft performance, enhance safety margins, and improve operational efficiency during phases of flight. As may be understood, the aircraft may prepare for and undertake a flight, and progresses through various stages from its originating location to a destination location. These stages may include pre-flight preparations, taxi, take-off, climb, cruise, descent, approach, and landing. Throughout each of these stages, the aircraft continuously interacts with a networked aviation ecosystem, exchanging data, receiving updates, and adjusting its operations based on real-time information.

To this end, a TOLD computation system may be implemented either within the aircraft, or externally, to determine the TOLD parameter based on real-time flight data, environmental conditions, and aircraft-specific characteristics. In an example, the TOLD computation system obtains a flight status corresponding the aircraft. The flight status specifies a flight-stage of the aircraft. As described above as well, examples of flight stages include, but are not limited to, a pre-flight stage, a take-off stage, a climbing stage, a cruise stage, a descent stage, an approach stage, and a landing stage.

Thereafter, the TOLD computation system retrieves configuration data including flight specific details corresponding to the flight stage of the aircraft from a data source. In an example, the configuration data is retrieved from the data source through an avionics interface integrated within the aircraft. In an example, the configuration data mainly includes data or data fields corresponding to atmospheric characteristics, runway characteristics and aircraft configuration corresponding to the flight stage specified by the flight status. Once obtained, the configuration data is segmented into a plurality of data fields to extract a value of a flight specific parameter corresponding to the flight stage of the aircraft. In an example, the flight specific parameter represents operational conditions corresponding to the flight stage of the aircraft.

The extracted value of the flight specific parameter is then analyzed to determine a TOLD parameter corresponding to the aircraft. In one example, the value of the flight specific parameter is analyzed with respect to a set of predefined set of rules to determine the TOLD parameter. In an example, the TOLD parameter includes data for effecting guided control of the aircraft during one of take-off and landing. In an example, the TOLD parameter is one of a take-off speed, a take-off runway length, a take-off weight limit, a landing speed, a landing runway length, a landing weight limit, or combination thereof.

In another example, the present subject matter may be implemented within a centralized flight management system which may communicate with the aircraft and/or other ground entities to obtain the required configuration data and thereafter transmit the calculated TOLD parameter to the aircraft. The centralized flight management system (referred to as centralized system) may be located at a ground station, a cloud-based platform, or within a distributed network architecture. Such centralized system may be capable of communicating with multiple aircraft, simultaneously, providing real-time TOLD computations to an entire fleet of aircraft.

In an example, the centralized system may receive a request from an aircraft for TOLD parameter computations, along with relevant flight data, such as an aircraft identifier. Based on the received request, the centralized system obtains the flight status to identify the flight stage of the aircraft. Thereafter, the system may access a wide range of data sources to retrieve configuration data including flight specific details corresponding the flight stage of the aircraft. Examples of data sources include, but are not limited to, Air Traffic Control (ATC), an Automatic Terminal Information Service (ATIS), a digital Automatic Terminal Information Service (D-ATIS), and among others. Once retrieved, the centralized system segments the configuration data to extract the value of the flight specific parameter and analyzes the same to determine the TOLD parameter. Thereafter, the centralized system communicates or transmits the TOLD parameter to the aircraft through a communication channel for effecting guided control of the aircraft during one of take-off and landing.

In yet another example, a machine learning model may be used to determine the TOLD parameter for the aircraft. For example, once the flight specific parameter is extracted from the configuration data, the flight specific parameter is fed into the machine learning model to determine the TOLD parameter. The machine learning model may be trained based on training information including various training flight-specific parameters and corresponding training TOLD parameters. The training process involves analyzing the relationships between these flight-specific parameters and their corresponding TOLD parameters across numerous flight scenarios and conditions. By learning these complex relationships, the model becomes capable of estimating TOLD parameters for an aircraft based on its current flight-specific parameters.

As will be explained further, the present approaches enable determining TOLD parameters for the aircraft based on flight-specific parameters and identified operational conditions. The system retrieves configuration data from various sources, segments this data into relevant fields, and extracts flight-specific parameters corresponding to the current flight stage. By analyzing these parameters, the system determines accurate TOLD parameters tailored to the specific operational context of the aircraft. Since the system processes real-time data from multiple sources, it may provide precise TOLD computations for individual aircraft under various flight conditions.

Additionally, the system may compare the determined TOLD parameters with predefined safety thresholds and generate alerts if necessary. These capabilities allow for optimized aircraft performance, enhanced safety during critical flight phases, and improved decision-making by pilots and flight crews. The real-time nature of the system also enables adaptability to changing flight conditions, ensuring that TOLD parameters remain relevant and accurate throughout the flight. These and other approaches are further explained in conjunction with the accompanying figures.

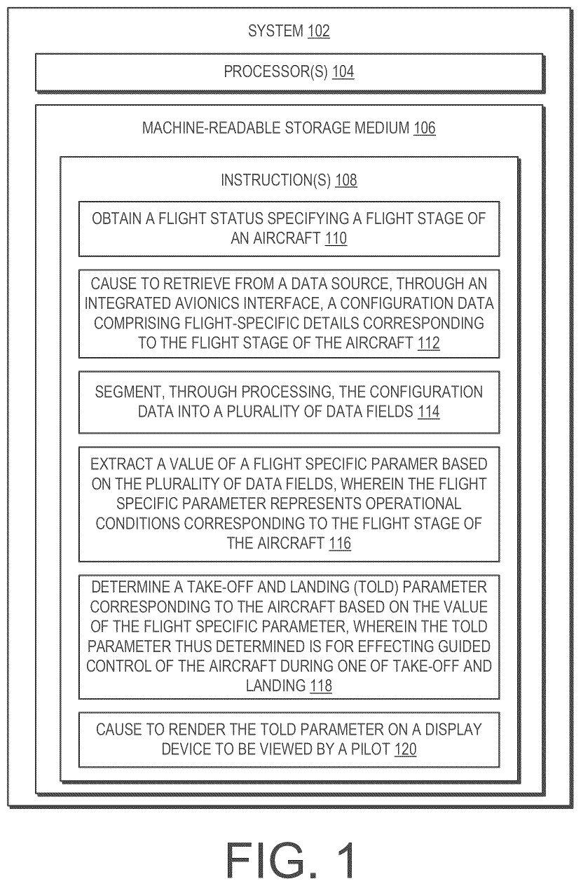

FIG. 1 illustrates an example system 102 for determining TOLD parameters for an aircraft. The determination of TOLD parameters is based on flight-specific details corresponding to the current flight stage of the aircraft, in accordance with an example of the present subject matter. The flight-specific details may reflect the aircraft's current operational conditions. The system 102 includes a processor 104, and a machine-readable storage medium 106 which is coupled to, and accessible by, the processor 104. The system 102 may be implemented in any computing system, such as an onboard aircraft computer, a ground-based server, a distributed computing system, or the like. Although not depicted, the system 102 may include other components, such as interfaces to communicate over the network or with external storage or computing devices, display, input/output interfaces, operating systems, applications, data, and the like, which have not been described for brevity.

The processor 104 may be implemented as a dedicated processor, a shared processor, or a plurality of individual processors, some of which may be shared. The machine-readable storage medium 106 may be communicatively connected to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to determine TOLD parameters for the aircraft.

In an example, the processor 104 may fetch and execute instructions 108. As a result of the execution of the instructions 110, the system 102 may obtain a flight status data specifying a flight stage of an aircraft. The flight stage may include pre-flight, take-off, climbing, cruise, descent, approach, or landing. In an example, the flight status data may include information such as current altitude, speed, position, or other relevant metrics that indicate the aircraft's current operational state. This data may be obtained directly from onboard sensors or from an integrated avionics interface where such information is collected and processed.

Once obtained, the instructions 112 may be executed to retrieve configuration data from a data source through an integrated avionics interface. The configuration data comprises flight-specific details corresponding to the flight stage of the aircraft. This data may include information from various sources such as Air Traffic Control (ATC), Automatic Terminal Information Service (ATIS), Notice to Air Missions (NOTAM) system, navigation databases, weather reports, and various sensors.

Once the configuration data is retrieved, the instructions 114 may be executed to segment, through processing, the configuration data into a plurality of data fields. This step involves analyzing the retrieved configuration data and breaking it down into distinct and meaningful categories or fields. In an example, the segmentation process may utilize various data processing techniques to identify and separate different types of information within the configuration data. For example, the text data may be parsed to extract specific values, separate numerical data from textual descriptions, or categorize information based on predefined data structures.

The instructions 116 may then be executed to extract a value of a flight specific parameter from the plurality of data fields. The flight specific parameter represents operational conditions corresponding to the flight stage of the aircraft. This step involves analyzing the segmented data fields to identify and isolate specific values that are relevant to the current flight stage and operational conditions. In an example, predefined set of rules or algorithms may be used to determine which data fields contain the necessary information for each flight specific parameter.

Once the flight specific parameter is extracted, the instructions 118 may be executed to determine a TOLD parameter corresponding to the aircraft. The TOLD parameter comprises performance data for effecting guided control of the aircraft during take-off and landing. In an example, the TOLD parameter include parameters such as take-off speed, take-off runway length, take-off weight limit, landing speed, landing runway length landing runway length, and landing weight limit.

Thereafter, the instructions 120 may be executed to cause to render the TOLD parameter on a display device to be viewed by a pilot. This step involves presenting the TOLD parameters in a clear, easily readable format on a display device within the aircraft cockpit. The display device may be part of the aircraft's existing avionics system, such as a multi-function display (MFD) or a dedicated TOLD display unit. The rendered information may include critical performance data such as take-off speeds (V1, VR, V2), take-off runway length required, take-off weight limits, approach speeds, landing distances, and landing weight limits.

The above functionalities performed as a result of the execution of the instructions 108, may be performed by different programmable entities. Such programmable entities may be implemented through various computing systems, which may be implemented either on a single computing device, or multiple computing devices. As will be explained, various examples of the present subject matter are described in the context of a computing system for determining TOLD parameters by using actual flight-specific parameters of the aircraft. These and other examples are further described with respect to other figures.

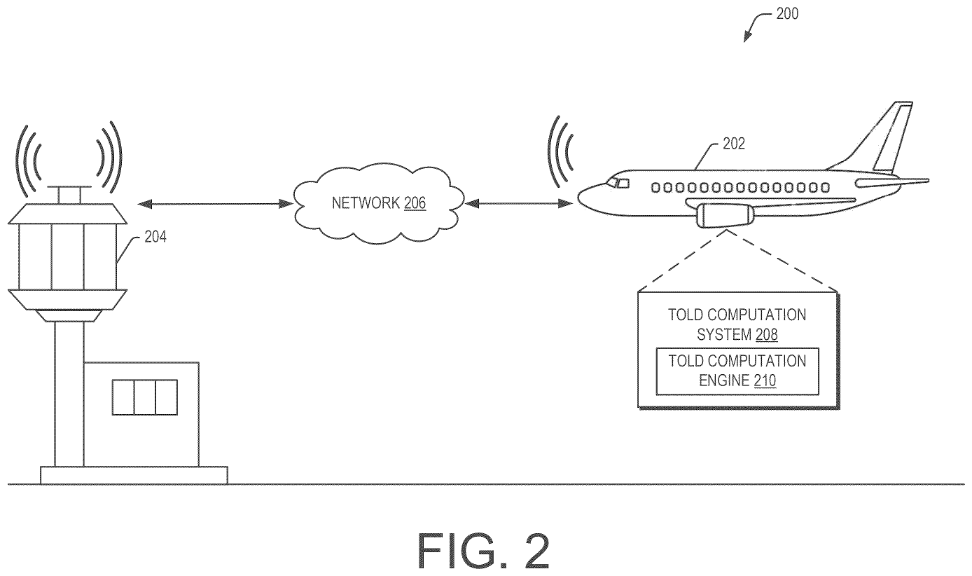

FIG. 2 illustrates an aircraft communication environment 200 (referred to as environment 200) comprising an aircraft 202 which may be in communication with a ground station 204. Such communication facilitates continuous data exchange between both through various phases of flight of the aircraft 202. In an example, the aircraft 202, depicted as a commercial airliner, is equipped with advanced avionics and communication systems to maintain constant communication with the ground-based facilities.

Further, the ground station 204, represented by a control tower, symbolizes various ground-based entities such as Air Traffic Control (ATC), airliner operations centers, and weather stations. Examples of such ground station 204 include, but are not limited to, Air Traffic Control (ATC) facilities, airline operations centers, airport management systems, weather information services, Automatic Terminal Information Service (ATIS) stations, flight planning centers, and aircraft maintenance and logistics support systems. The ground station 204 may also be equipped with advanced communication technologies, radar systems, weather monitoring equipment, and data processing capabilities to assist aircraft in safe and efficient operations from pre-flight planning through post-flight procedures.

For example, during pre-flight, the aircraft 202 receives flight plans, weather briefings, NOTAMs from the ground station 204. As the flight progresses through taxi, take-off, climb, cruise, descent, approach, and landing, the ground station 204 provides real-time updates on weather, runway conditions, traffic, and navigational information. The aircraft 202 also transmits its position, status, and intentions, allowing for optimized flight paths and traffic management.

The aircraft 202 is in communication with the ground station 204 through a network 206. Examples of such network 206 that may connect the aircraft 202 with the ground station 204 include, but are not limited to, Aircraft Communications Addresing and Reporting System (ACARS), Very High Frequency (VHF) Data Link (VDL), High Frequency Data Link (HFDL), Satellite Communications (SATCOM) networks, Aeronautical Mobile Airport Communication System (AeroMACS), Controller-Pilot Data Link Communications (CPDLC), Automatic Dependent Surveillance-Contract (ADS-C), and Future Air Navigation System (FANS) networks.

The environment 200 further includes a TOLD computation system 208 for determining a TOLD parameter corresponding to the aircraft 202. It may be implemented within the aircraft 202, at ground station 204, or as a separate entity connected to the network 206. The TOLD computation system 208 (referred to as system 208) may further include a TOLD computation engine 210, which performs the computation of the TOLD parameters. In an example, to compute the values of the TOLD parameters, the TOLD computation engine 210 (referred to as engine 210) require a configuration data representing operational conditions of the flight of the aircraft 202 from various data sources corresponding to the current stage of the flight of the aircraft 202.

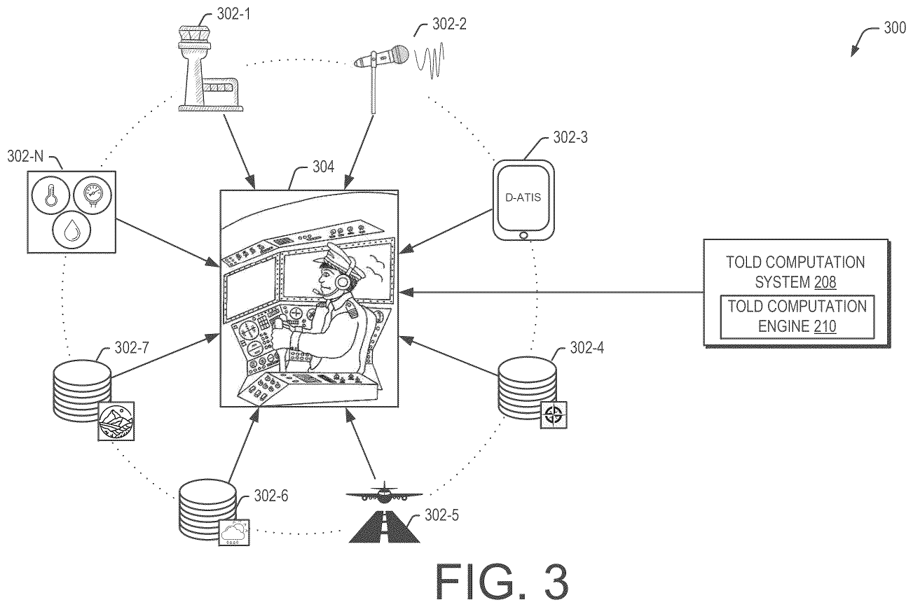

The examples of various data sources and the manner in which the data is obtained from these data sources is depicted in FIG. 3. FIG. 3 illustrates a functional diagram 300 depicting communication of data from a plurality of data sources 302-1, 302-2, . . . , 302-N (referred to as data source(s) 302) to the system 208 through an avionics interface 304 integrated within the aircraft 202. The avionics interface 304 is in communication with variety of data source(s) 302 through various communication channels using various communication protocols. For example, the avionics interface 304 includes standardized communication protocols to interface with various avionics systems, data buses, and external data links, to seamlessly gather information from both onboard and ground-based data source(s) 302.

Examples of data source(s) 302 include, but are not limited to, Air traffic control system 302-1, an Automatic Terminal Information Service (ATIS) 302-2, a digital ATIS 302-3, a navigational database 302-4, an airport moving map 302-5, an Aviation Routine Weather Report (METAR) 302-6, a terrain database 302-7, and a plurality of sensors 302-8. It may be noted that, only limited number of data source(s) 302 are depicted in FIG. 3 and there may be other data source(s) whose data may be obtained and used for determining the TOLD parameter.

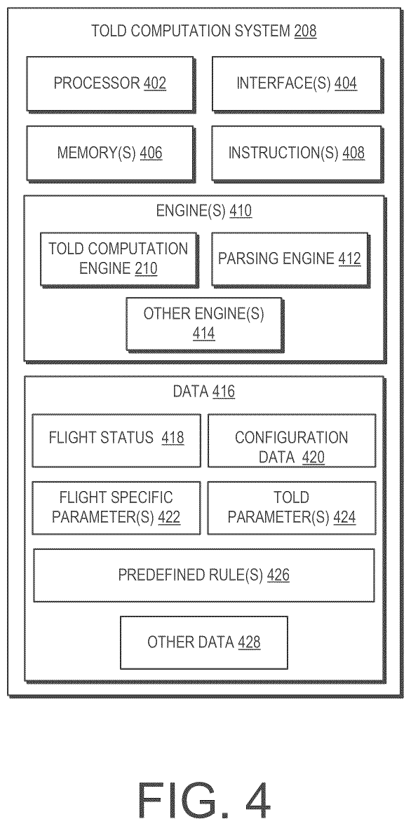

In addition, the avionics interface 304 includes components such as data bus interfaces, communication management units for handling datalink communications, network switches for routing data between various aircraft systems, data concentrators for aggregating information from multiple sensors, and human-machine interface components like multifunction displays and touchscreen controls for pilot interaction and data presentation. The avionics interface 304 may also include speakers for communicating information from ATC 302-1 to the pilot, for real-time audio transmission of critical flight instructions and updates. The avionics interface 304 communicates with data source(s) 302 to receive data and such data is selectively obtained by the system 208 based on the current flight stage to determine the TOLD parameters corresponding to the aircraft 202. These aspects are further explained in detail in conjunction with FIG. 4.

FIG. 4 depicts various functional blocks of the system 208, as per an example. The system 208 includes a processor 402, interface(s) 404 and memory(s) 406. The processor 402 may be implemented as microprocessors, microcomputers, microcontrollers, digital signal processors, central processing units, state machines, logic circuitries, and/or other devices that manipulate signals based on operational instructions. The interface(s) 404 may allow the connection or coupling of the system 208 with one or more other devices, through a wired (e.g., Local Area Network, i.e., LAN) connection or through a wireless connection (e.g., Bluetooth®, Wi-Fi). The interface(s) 404 may also enable intercommunication between different logical as well as hardware components of the system 208. The interface(s) 404 may also enable the system 208 to communicate with other entities, such as the avionics interface 304, (as depicted in FIG. 3), or other devices or systems.

The memory(s) 406 may be a computer-readable medium, examples of which include volatile memory (e.g., RAM), and/or non-volatile memory (e.g., Erasable Programmable read-only memory, i.e., EPROM, flash memory, etc.). The memory(s) 406 may be an external memory, or internal memory, such as a flash drive, a compact disk drive, an external hard disk drive, or the like. The memory(s) 406 may further include data which either may be utilized or generated during the operation of the system 208.

The system 208 may further include instructions 408 and engine(s) 410. In an example, the instructions 408 are fetched from the memory 406 and executed by the processor 402 included within the system 208. The engine(s) 410 may include a TOLD computation engine, such as engine 210, a parsing engine 412, and other engine(s) 414. The other engine(s) 414 may further implement functionalities that supplement functions performed by the system 208 or any of the engine(s) 410. The engine 210 and parsing engine 412 may be implemented as a combination of hardware and programming, for example, programmable instructions to implement a variety of functionalities. In examples described herein, such combinations of hardware and programming may be implemented in several different ways.

For example, the programming for the engine 210 and parsing engine 412 may be executable instructions, such as instructions 408. Such instructions 408 may be stored on a non-transitory machine-readable storage medium which may be coupled either directly with the system 208 or indirectly (for example, through networked means). In an example, the engine 210 and parsing engine 412 may include a processing resource, for example, either a single processor or a combination of multiple processors, to execute such instructions. In the present examples, the non-transitory machine-readable storage medium may store instructions, such as instructions 408, that when executed by the processing resource, implement the engine 210 and parsing engine 412. In another example, the engine 210 and parsing engine 412 may be implemented as electronic circuitry.

The system 208 may further include a data 416. The data may include corresponding data that is utilized or generated by the system 208, while performing a variety of functions. In an example, the data 416 further includes a flight status 418, a configuration data 420, a flight specific parameter(s) 422, a TOLD parameter(s) 424, a predefined set of rule(s) 426, and other data 428. Further, the other data 428, amongst other things, may serve as a repository for storing data that is processed, or received, or generated as a result of the execution of the instructions by the processor 402.

In an example, the configuration data 420 includes atmospheric characteristics, such as surface wind direction and speed, outside air temperature, and altimeter setting, runway characteristics including runway length, width, surface condition, and braking action, and aircraft configuration details, such as flap settings, autobrake settings, and thrust reverser settings. The flight specific parameter(s) 422 include operational conditions corresponding to the current flight stage, such as aircraft weight, fuel load, obstacle information, and environmental conditions like visibility and precipitation, and amongst other flight specific details. The TOLD parameter(s) 424 include take-off speed, take-off runway length, take-off weight limit, landing speed, landing runway length, and landing weight limit.

Further, the predefined set of rule(s) 426 include safety thresholds for flight parameters, regulatory requirements for take-off and landing operations, aircraft-specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension requirements, brake cooling requirements, and tire speed limitations.

It may be noted that such examples of the various functional blocks as depicted in FIG. 4 are indicative. The present approaches may be applicable to other examples without deviating from the scope of the present subject matter.

The working of the system 208 (via functional blocks as depicted in FIG. 4) is explained in conjunction with various elements of the environment 200 and functional diagram 300 (as described in FIG. 2 and FIG. 3, respectively). In operation, initially, the engine 210 of the system 208 may obtain the flight status 418 specifying a flight stage of the aircraft 202. As may be understood, the aircraft 202 may be in any of several possible flight stages, such as pre-flight, take-off, climbing, cruise, descent, approach, or landing. By obtaining the flight status, the engine 210 ascertains the current flight stage of the aircraft 202, which enables it to subsequently retrieve selected or relevant data from various data source(s) 302.

For example, if the engine 210 determines that the aircraft 202 has already taken off, it may focus on retrieving configuration data relevant to the current and upcoming flight stages. In this case, obtaining configuration data corresponding to pre-flight or take-off stages becomes unnecessary. The engine 210 may instead prioritize gathering data related to climbing, cruise, and potential descent scenarios. This flight status 418 may be obtained through various means, such as from the aircraft's onboard systems, communication with the ground station 204, or via the network 206.

Once obtained, the engine 210 may retrieve configuration data 420 comprising flight-specific details corresponding to the flight stage of the aircraft 202. This retrieval process is executed through the integrated avionics interface 304, which serves as a central hub for accessing various data source(s) 302 both onboard the aircraft 202 and from external systems. The configuration data 420 may encompass a wide range of flight-specific details, depending on the current flight stage. For instance, during the pre-flight stage, the engine 210 may retrieve data such as current weather conditions at the departure airport, runway conditions and length, aircraft weight and balance information, fuel load and distribution, and planned route and altitude. Similarly, the engine 210 retrieve configuration data corresponding to various flight stages of the aircraft 202.

Thereafter, the parsing engine 412 segments the configuration data 420 into a plurality of data fields. In an example, this segmentation process involves breaking down the retrieved configuration data 420 into distinct, categorized units of information that may be easily processed and analyzed. The parsing engine 412 may employ various techniques to identify and separate different types of data within the configuration information. Once segmented, the parsing engine 412 extracts values of flight specific parameter(s) 422 based on the plurality of data fields. In an example, the flight specific parameter(s) 422 represent operational conditions corresponding to the current flight stage of the aircraft 202. The extraction process involves analyzing the segmented data fields to identify and isolate the relevant values that are crucial for TOLD computations.

For example, if the aircraft is in the take-off stage, the parsing engine 412 may extract values, such as runway length, runway slope, outside air temperature, barometric pressure, wind direction, wind speed, aircraft gross weight, flap setting, etc. Each of these extracted values represent a specific operational condition that directly impacts the aircraft's performance and safety during take-off. Similarly, for other flight stages, the parsing engine 412 extracts relevant parameters. During the cruise stage, it might focus on extracting values related to altitude, airspeed, and fuel consumption. For the landing stage, it could extract data on approach speed, landing weight, and runway conditions at the destination airport.

As described above as well, the parsing engine 412 may employ various techniques to identify and separate different types of data within the configuration information. For example, in the case where the configuration data 420 is obtained from a data source in the form of an audio signal, the segmentation process may involve additional steps. Initially, the audio signal, which could be an Air Traffic Control (ATC) transmission or an Automatic Terminal Information Service (ATIS) broadcast, is converted into text using an audio transcription technique. This transcription technique may utilize speech recognition algorithms optimized for aviation terminology and phraseology.

Once the audio is converted to text, the parsing engine 412 analyzes the text to extract flight specific parameter(s) 422, focusing particularly on information related to the take-off and landing stages of the aircraft. This analysis may involve natural language processing techniques to identify key phrases, numerical values, and relevant aviation terms within the transcribed text. The extracted flight specific parameters are then processed by the parsing engine 412 to convert them into a standardized format compatible with the system's TOLD parameter determination algorithms. This standardization may involve unit conversions (e.g., converting temperatures from Celsius to Fahrenheit, or wind speeds from knots to meters per second), normalizing terminology, and structuring the data into predefined fields or categories.

For instance, if the original audio message contained the phrase “wind two seven zero at fifteen knots, gusting to twenty-five,” the parsing engine 412 might segment this into separate data fields such as, Wind direction: 270 degrees, Wind speed: 15 knots, Wind gust: 25 knots. Similarly, other relevant information like runway conditions, temperature, pressure, and visibility would be extracted and categorized into appropriate data fields.

Returning to the present example, once the flight specific parameter(s) 422 are extracted, the engine 210 displays these parameters on a display device to be viewed by the pilot. This display device may be integrated into the aircraft's cockpit instrumentation, such as on a multi-function display or a dedicated TOLD parameter screen. The flight specific parameter(s) 422 are presented in a clear, easily readable format, potentially using both numerical values and graphical representations.

The pilot is then given the opportunity to review these displayed flight specific parameter(s) 422 to check their correctness. For example, the pilot may confirm that the displayed parameters are accurate and align with their observations and other available information. If the pilot identifies any discrepancies or has more up-to-date information, the system 208 allows for modifications to be made directly through the display interface. For instance, if the pilot receives a last-minute update on wind conditions from air traffic control, the pilot may input this new information, overriding the previously extracted value.

Once the pilot has reviewed and, if necessary, modified the flight specific parameter(s) 422, the pilot may confirm the final set of values. In an example, this confirmation may be done through a simple button press or touch screen interaction, signaling to the system 208 that the displayed parameters are accurate and approved for use in TOLD computations.

The engine 210 then utilizes these confirmed or modified flight specific parameter(s) 422 for determining the TOLD parameter(s) 424. To determine the TOLD parameter(s) 424, the engine 210 first analyzes the flight specific parameter(s) 422 with respect to a predefined set of rules, such as predefined set of rule(s) 426. The predefined set of rule(s) 426 may encompass safety thresholds for flight parameters, regulatory requirements for take-off and landing operations, aircraft-specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension requirements, brake cooling requirements, and tire speed limitations.

This analysis involves evaluating each flight specific parameter against the relevant rules to determine its impact on the TOLD parameter(s) 424. For example, runway length is analyzed against aircraft performance data to determine if it's sufficient for take-off or landing under the current conditions, wind speed and direction are evaluated to calculate their effect on take-off and landing distances, as well as to ensure they're within the aircraft's crosswind limitations, temperature and pressure altitude are analyzed to determine their impact on engine performance and lift generation, which in turn affects take-off and landing speeds and distances, and aircraft weight is checked against maximum take-off and landing weight limits, and its impact on performance is calculated.

Based on this analysis, the engine 210 determines the appropriate TOLD parameters. For instance, if the analysis shows that the runway length is near the minimum required for the current weight and environmental conditions, the engine 210 may calculate a higher V1 speed to allow for a longer acceleration distance. In another example, if crosswind components are high, the engine may adjust the minimum control speeds accordingly. Further, if the temperature is significantly above standard, the engine may calculate increased take-off and landing distances and higher V-speeds to account for decreased aircraft performance.

These TOLD parameter(s) 424 are specifically calculated to affect the guided control of the aircraft 202 during take-off or landing. They provide critical information that directly influences how the aircraft 202 should be operated during these crucial phases of flight. For instance, during take-off, the V-speeds (V1, VR, V2) guide the pilot's actions in terms of when to abort a take-off, when to rotate the aircraft, and what speed to maintain for initial climb. The runway length and weight parameters ensure the aircraft may safely become airborne within the available runway distance. Similarly, for landing, the approach speed and landing distance parameters guide the pilot in configuring the aircraft for a safe approach and touchdown, ensuring sufficient runway is available for the aircraft to come to a complete stop.

Continuing further, once the TOLD parameter(s) 424 are determined, the engine 210 compares the value of each TOLD parameter with a corresponding predefined safety threshold. These safety thresholds may be stored in a database within the system 208 and may be specific to the aircraft type, operational conditions, and regulatory requirements.

If the engine 210 determines that any TOLD parameter value exceeds its corresponding safety threshold, it generates an alert for the pilot. This alert may be presented visually on the display device, accompanied by an audible warning, or both. For example, if the calculated take-off distance exceeds 90% of the available runway length (a potential safety threshold), the system would generate an alert to inform the pilot of this critical situation.

Additionally, the engine 210 analyzes the TOLD parameter(s) 424 in conjunction with historical flight data and the current flight specific parameter(s) 422. This analysis is performed to provide a set of aircraft configuration suggestions that may optimize performance and safety for the current take-off or landing operation. Examples of aircraft configuration suggestions include, but may not be limited to, flap setting recommendations, Autobrake setting adjustments, Thrust reverser deployment strategies, Anti-ice system activation recommendations, Anti-skid system engagement advice, and Ground spoiler deployment suggestions.

For instance, based on the analysis of runway conditions (derived from the flight specific parameters) and the calculated landing distance (a TOLD parameter), the engine 210 might suggest a higher autobrake setting to ensure the aircraft may stop within the available runway length. These configuration suggestions are then presented to the pilot via the display device, alongside the TOLD parameter(s) 424 and any generated alerts. This comprehensive display of information allows the pilot to make informed decisions about aircraft configuration and operation during the critical phases of take-off and landing.

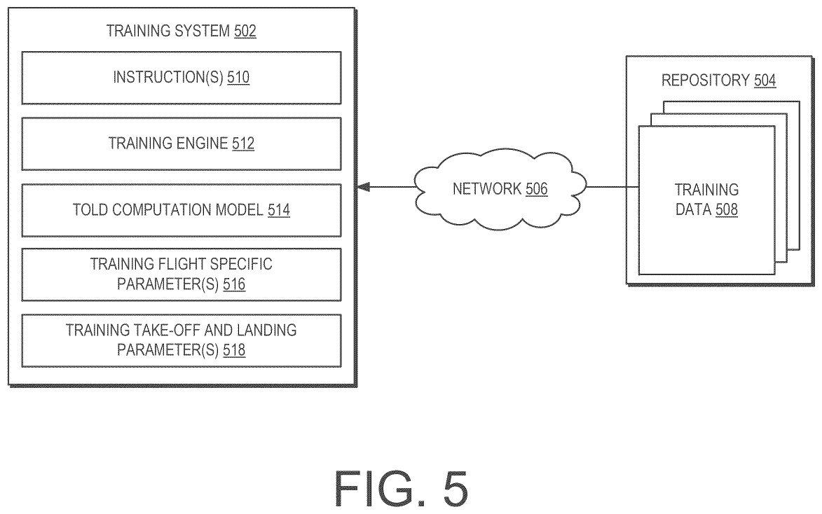

In another example, the determination of TOLD parameter(s) 424 may be done using a machine learning model which is trained based on actual flight conditions and corresponding TOLD parameters observed during those actual flights. The machine learning model in conjunction with the engine 210 may analyze the flight specific parameters extracted from the configuration data to determine the TOLD parameters. The training process of such machine learning model is explained in conjunction with FIG. 5.

FIG. 5 illustrates a training system 502 comprising a processor or memory (not shown), for training a TOLD computation model to determine a value of a TOLD parameter that, when followed by the pilot of the aircraft, is set to control the operations of the aircraft efficiently during take-off and landing. In an example, the training system 502 may be communicatively coupled to a repository 504 through a network 506. The repository 504 may further include a training data 508. The training data 508 may include training values of flight specific parameters and corresponding training values of TOLD parameters obtained or recorded during actual flight conditions.

Examples of flight specific parameters include, but are not limited to, atmospheric characteristics (such as surface wind direction and speed, outside air temperature, and altimeter setting), runway characteristics (including runway length, width, surface condition, and braking action), aircraft configuration (such as flap settings, autobrake settings, and thrust reverser settings), obstacle information (including location, height, and type of obstacles near the runway), aircraft weight and balance data, engine performance characteristics, fuel load, and environmental conditions (such as visibility, precipitation, and icing conditions). These parameters may also encompass crosswind and tailwind limitations, minimum and maximum speed constraints, and specific operational requirements like noise abatement procedures or obstacle clearance requirements.

It may be noted that the above-described examples of flight specific parameters are indicative of parameters which are generally used for determining or calculating the TOLD parameter. However, any other examples of such parameters may also be used without deviating from the scope of the present subject matter.

On the other hand, examples of TOLD parameters may include, but are not limited to, take-off speed, a take-off runway length, a take-off weight limit, a landing speed, a landing runway length, and a landing weight limit.

The training data 508, although depicted as being obtained from a single repository, such as repository 504, may also be obtained from multiple other sources without deviating from the scope of the present subject matter. In such cases, each of such multiple repositories may be interconnected through a network, such as the network 506.

The network 506 may be a private network or a public network and may be implemented as a wired network, a wireless network, or a combination of a wired and wireless network. The network 506 may also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN).

The training system 502 may further include instructions 510 and a training engine 512. In an example, the instructions 510 are fetched from a memory and executed by a processor included within the training system 502. The training engine 512 may be implemented as a combination of hardware and programming, for example, programmable instructions to implement a variety of functionalities. In examples described herein, such combinations of hardware and programming may be implemented in several different ways. For example, the programming for the training engine 512 may be executable instructions, such as instructions 510. Such instructions may be stored on a non-transitory machine-readable storage medium which may be coupled either directly with the training system 502 or indirectly (for example, through networked means). In an example, the training engine 512 may include a processing resource, for example, either a single processor or a combination of multiple processors, to execute such instructions. In the present examples, the non-transitory machine-readable storage medium may store instructions, such as instructions 510, that when executed by the processing resource, implement the training engine 512. In other examples, the training engine 512 may be implemented as electronic circuitry.

The instructions 510 when executed by the processing resource, cause the training engine 512 to train an artificial intelligence-based machine learning model, such as a TOLD computation model 514. In an example, the TOLD computation model 514, in context of FIG. 5 is trained based on training values of flight specific parameters and corresponding training values of TOLD parameters which are recorded during actual flight conditions. The training system 502 may further include training flight specific parameter(s) 516 comprising values of various parameters which are specific to flight operations that may affect take-off and landing performance, such as atmospheric conditions, runway characteristics, aircraft configuration, and obstacle information. The training TOLD parameter(s) 518 comprise values of TOLD parameters indicating critical performance data for take-off and landing operations, including but not limited to take-off and landing speeds, required runway lengths, weight limits, and climb gradients. These parameters are collected from a wide range of flight scenarios and conditions to ensure the model's ability to accurately predict TOLD parameters across diverse operational contexts.

In an example, the training system 502 may obtain single training data 508 at one time which may be corresponding to a single flight of the aircraft, and the information pertaining to that is stored as training flight specific parameter(s) 516 and training TOLD parameter(s) 518.

In operation, the training system 502 may obtain the training data 508 from the repository 504 and data included in the training data 508 may be further stored as training flight specific parameter(s) 516 and training TOLD parameter(s) 518 in the training system 502. Thereafter, the training flight specific parameter(s) 516 and corresponding training TOLD parameter(s) 518 are processed to identify correlations between these two types of parameters. The training system 502 may analyze the relationship between various flight specific parameters and their corresponding TOLD parameters to determine which parameters have significant influences on take-off and landing performance.

Once the correlations are identified, the training engine 512 trains the TOLD computation model 514 (referred to as model 514) based on these correlations. The model 514 learns to recognize patterns and relationships between the flight specific parameters and the resulting TOLD parameters. This training process enables the model 514 to understand how different combinations of flight specific parameters affect take-off and landing performance. In an example, the correlations identified may include both direct and indirect relationships between flight specific parameters and TOLD parameters. For instance, the model 514 may learn how changes in atmospheric conditions directly affect take-off speeds, or how runway characteristics indirectly influence required take-off distances through their impact on acceleration rates. The model 514 is trained to recognize complex interactions between multiple flight specific parameters and their collective impact on TOLD parameters. This may include understanding how combinations of factors like aircraft weight, runway length, and atmospheric conditions jointly determine take-off performance.

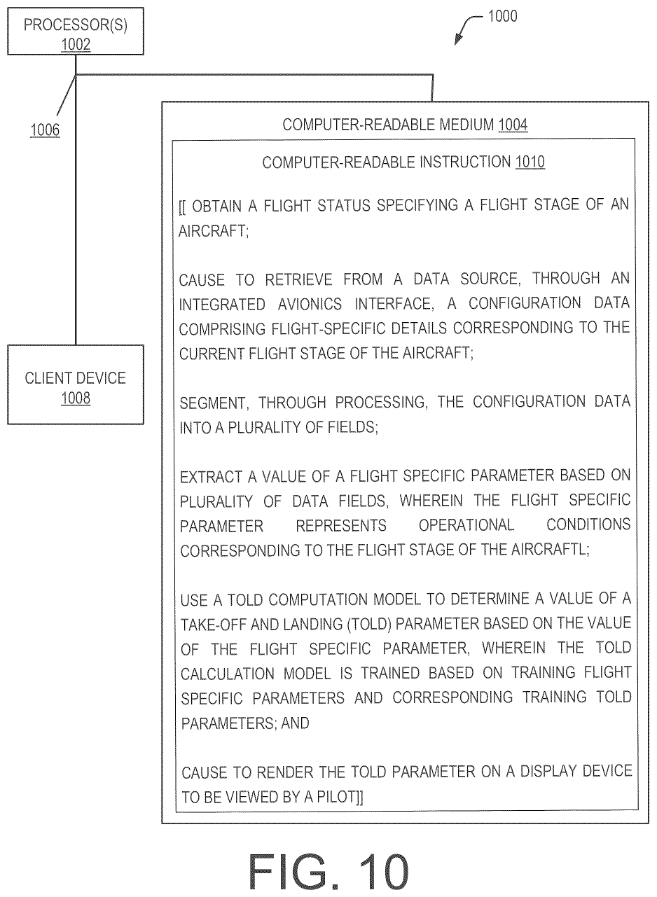

Once trained, the model 514 may be utilized to estimate TOLD parameters based on given flight specific parameters. For example, when provided with a set of current flight specific parameters for an aircraft preparing for take-off, the model may analyze these inputs and estimate the appropriate TOLD parameters for that specific flight condition. The manner in which the value of TOLD parameter for an ongoing flight of an aircraft is determined or calculated in real-time by the trained model 514 is further described in detail in conjunction with FIG. 10.

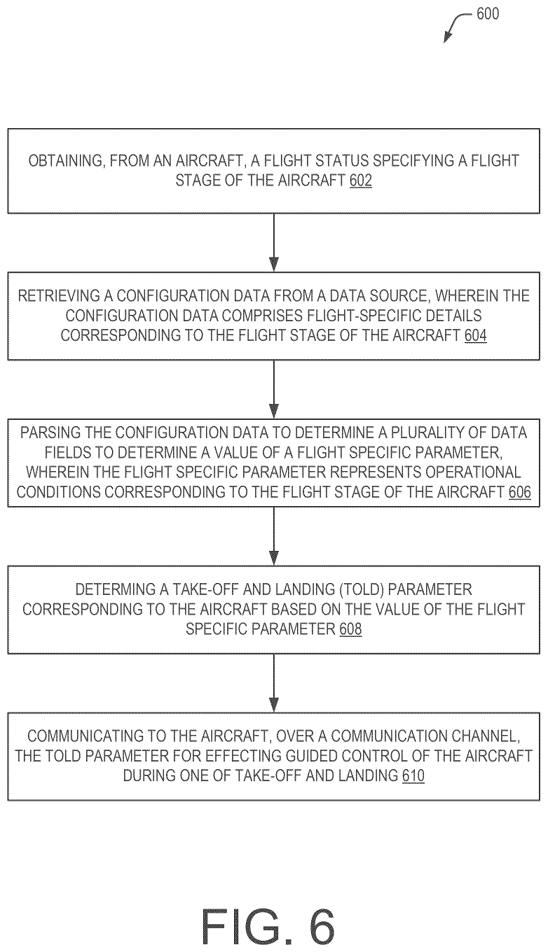

FIG. 6 illustrates a method 600, performed by a system implemented within a ground station, for determining TOLD parameters for an aircraft and communicating the TOLD parameters with the aircraft, as per an example. The order in which the method 600 is described is not intended to be construed as a limitation, and some of the described method blocks may be combined in a different order to implement the method, or an alternative method.

Furthermore, the method 600 may be implemented in suitable hardware, computer-readable instructions, or a combination thereof. The steps of such method may be performed by either a system under the instruction of machine executable instructions stored on a non-transitory computer readable medium or by dedicated hardware circuits, microcontrollers, or logic circuits. For example, the method 600 may be implemented by a TOLD computation system, such as system 208, as shown in FIG. 2-4. In an implementation, the method may be performed under an “as a service” delivery model, where the system 208, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

In an example, the method 600 may be implemented by the system 208 for determining the TOLD parameter and communicating the same to the aircraft for effecting guided control of the aircraft. At block 602, a flight status specifying a flight stage of an aircraft is obtained from the aircraft. The TOLD computation system, such as system 208, when implemented within the ground station, may obtain or receive flight status from the aircraft 202 through the network 206. In another example, the system 208 which is implemented within the ground station 204 may obtain the flight status from a monitoring device installed within the ground station 204 itself which is monitoring the status of the aircraft 202. This ground-based monitoring device may track the aircraft's position, altitude, speed, and other relevant parameters to determine its current flight stage. Once received, the flight status is stored as flight status 418 within the data 416 section of the system 208.

At block 604, a configuration data is retrieved from a data source, wherein the configuration data includes flight specific details corresponding to the flight stage of the aircraft. For example, the system 208 may retrieve configuration data from various data source(s) 302 shown in FIG. 3, such as air traffic control 302-1, automatic terminal information service 302-2, Digital-ATIS 302-3, navigational database 302-4, airport moving map 302-5, Aviation Routine Weather Report (METAR) 302-6, terrain database 302-7, or sensor array 302-N. This configuration data may include atmospheric conditions, runway characteristics, aircraft weight, and other relevant flight-specific details for the current flight stage.

At block 606, the configurated data is parsed to determine a plurality of data fields to determine a value of a flight specific parameter. For example, the parsing engine 412 within the engine 210, as shown in FIG. 4, may segment the retrieved configuration data into multiple data fields. These fields may include atmospheric pressure, temperature, wind speed and direction, runway length, runway condition, aircraft weight, and fuel load. From these fields, the system extracts values for flight specific parameters such as density altitude, headwind component, or runway friction coefficient.

At block 608, a take-off and landing parameter is determined based on the value of the flight specific parameter corresponding to the aircraft. For example, the engine 210 may use the extracted flight specific parameters to compute TOLD parameter(s) 424 such as take-off speed, take-off runway length, take-off weight limit, landing speed, landing runway length, or landing weight limit. This computation may involve applying the flight specific parameters to predefined set of rule(s) 426 stored in the system, which may represent aircraft performance models or regulatory requirements.

At block 610, the TOLD parameter is communicated, over a communication channel, to the aircraft for effecting guided control of the aircraft during one of take-off and landing. For example, the determined TOLD parameters may be transmitted from the system 208 to the aircraft 202 through the network 206, as illustrated in FIG. 2. Once received by the aircraft, these parameters may be displayed to the pilot through the integrated avionics interface 304 (FIG. 3), or used directly by the aircraft's flight control systems to adjust take-off or landing configurations, such as flap settings, engine thrust levels, or approach speeds.

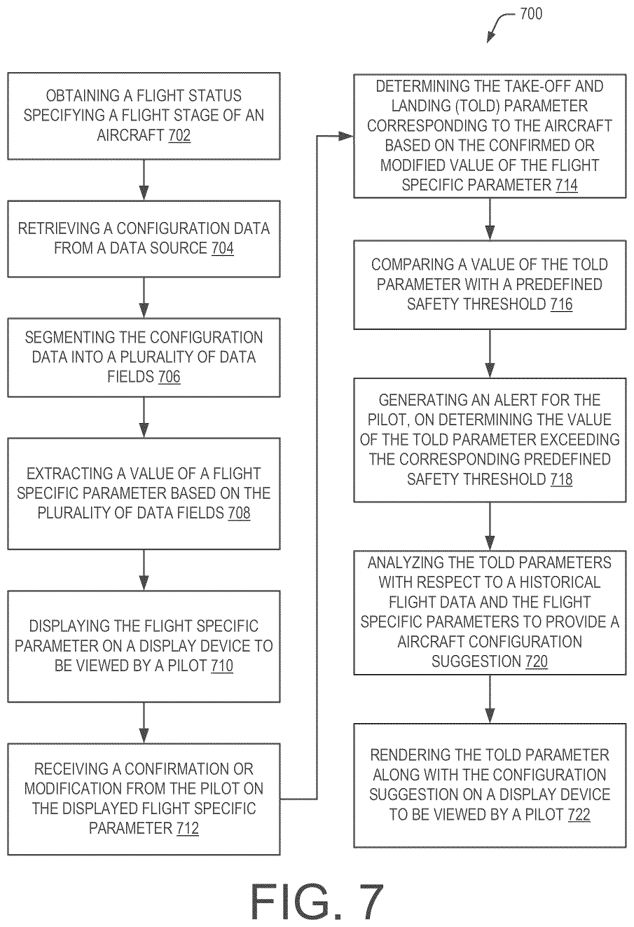

FIG. 7 illustrates a method 700, performed by a TOLD computation system implemented within an aircraft, for determining a TOLD parameter, as per an example. The order in which the above-mentioned method is described is not intended to be constructed as a limitation, and some of the described method block may be combined in a different order to implement the method, or an alternative method.

Furthermore, the above-mentioned method 700 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a TOLD computation system, such as system 208. In an implementation, the method may be performed under an “as a service” delivery model, where the system 208 operated by a provider, receives programmable code. Herein, some examples are also intended to cover non-transitory computer readable medium, for example, digital data storage media, which are computer readable and encode computer-executable instructions, where said instructions performed some or all the steps of the above-mentioned methods.

At block 702, a flight status specifying a flight stage of an aircraft is obtained. For example, the engine 210 of the system 208 may obtain the flight status 418 specifying a flight stage of the aircraft 202. As may be understood, the aircraft 202 may be in any of several possible flight stages, such as pre-flight, take-off, climbing, cruise, descent, approach, or landing. By obtaining the flight status, the engine 210 ascertains the current flight stage of the aircraft 202, which enables it to subsequently retrieve selected or relevant data from various data source(s) 302.

For example, if the engine 210 determines that the aircraft 202 has already taken off, it may focus on retrieving configuration data relevant to the current and upcoming flight stages. In this case, obtaining configuration data corresponding to pre-flight or take-off stages becomes unnecessary. The engine 210 may instead prioritize gathering data related to climbing, cruise, and potential descent scenarios. This flight status 418 may be obtained through various means, such as from the aircraft's onboard systems, communication with the ground station 204, or via the network 206.

At block 704, a configuration data is retrieved from a data source. For example, the engine 210 may retrieve configuration data 420 comprising flight-specific details corresponding to the flight stage of the aircraft 202. This retrieval process is executed through the integrated avionics interface 304, which serves as a central hub for accessing various data source(s) 302 both onboard the aircraft 202 and from external systems. The configuration data 420 may encompass a wide range of flight-specific details, depending on the current flight stage. For instance, during the pre-flight stage, the engine 210 may retrieve data such as current weather conditions at the departure airport, runway conditions and length, aircraft weight and balance information, fuel load and distribution, and planned route and altitude. Similarly, the engine 210 retrieve configuration data corresponding to various flight stages of the aircraft 202.

At block 706, the configuration data is segmented into a plurality of fields. For example, the parsing engine 412 segments the configuration data 420 into a plurality of data fields. In an example, this segmentation process involves breaking down the retrieved configuration data 420 into distinct, categorized units of information that may be easily processed and analyzed. The parsing engine 412 may employ various techniques to identify and separate different types of data within the configuration information.

At block 708, a value of a flight specific parameter is extracted based on the plurality of fields. For example, the parsing engine 412 extracts values of flight specific parameter(s) 422 based on the plurality of data fields. In an example, the flight specific parameter(s) 422 represent operational conditions corresponding to the current flight stage of the aircraft 202. The extraction process involves analyzing the segmented data fields to identify and isolate the relevant values that are crucial for TOLD computations.

For example, if the aircraft is in the take-off stage, the parsing engine 412 may extract values, such as runway length, runway slope, outside air temperature, barometric pressure, wind direction, wind speed, aircraft gross weight, flap setting, etc. Each of these extracted values represent a specific operational condition that directly impacts the aircraft's performance and safety during take-off. Similarly, for other flight stages, the parsing engine 412 extracts relevant parameters. During the cruise stage, it might focus on extracting values related to altitude, airspeed, and fuel consumption. For the landing stage, it could extract data on approach speed, landing weight, and runway conditions at the destination airport.

As described above as well, the parsing engine 412 may employ various techniques to identify and separate different types of data within the configuration information. For example, in the case where the configuration data 420 is obtained from a data source in the form of an audio signal, the segmentation process may involve additional steps. Initially, the audio signal, which could be an Air Traffic Control (ATC) transmission or an Automatic Terminal Information Service (ATIS) broadcast, is converted into text using an audio transcription technique. This transcription may utilize speech recognition algorithms optimized for aviation terminology and phraseology.

Once the audio is converted to text, the parsing engine 412 analyzes the text to extract flight specific parameter(s) 422, focusing particularly on information related to the take-off and landing stages of the aircraft. This analysis may involve natural language processing techniques to identify key phrases, numerical values, and relevant aviation terms within the transcribed text. The extracted flight specific parameters are then processed by the parsing engine 412 to convert them into a standardized format compatible with the system's TOLD parameter determination algorithms. This standardization may involve unit conversions (e.g., converting temperatures from Celsius to Fahrenheit, or wind speeds from knots to meters per second), normalizing terminology, and structuring the data into predefined fields or categories.

At block 710, the flight specific parameter is displayed on a display device to be viewed by a pilot. For example, the engine 210 displays these parameters on a display device to be viewed by the pilot. This display device may be integrated into the aircraft's cockpit instrumentation, such as on a multi-function display or a dedicated TOLD parameter screen. The flight specific parameter(s) 422 are presented in a clear, easily readable format, potentially using both numerical values and graphical representations.

At block 712, a confirmation or modification in the displayed flight specific parameter is received. For example, the pilot may confirm that the displayed parameters are accurate and align with their observations and other available information. If the pilot identifies any discrepancies or has more up-to-date information, the system 208 allows for modifications to be made directly through the display interface. For instance, if the pilot receives a last-minute update on wind conditions from air traffic control, the pilot may input this new information, overriding the previously extracted value.

Once the pilot has reviewed and, if necessary, modified the flight specific parameter(s) 422, the pilot may confirm the final set of values. In an example, this confirmation may be done through a simple button press or touch screen interaction, signaling to the system 208 that the displayed parameters are accurate and approved for use in TOLD computations.

At block 714, a take-off and landing parameter corresponding to the aircraft is determined based on the flight specific parameter. For example, The engine 210 then utilizes these confirmed or modified flight specific parameter(s) 422 for determining the TOLD parameter(s) 424. To determine the TOLD parameters, the engine 210 first analyzes the flight specific parameter(s) 422 with respect to a predefined set of rules, such as predefined set of rule(s) 426. The predefined set of rule(s) 426 may encompass safety thresholds for flight parameters, regulatory requirements for take-off and landing operations, aircraft-specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension requirements, brake cooling requirements, and tire speed limitations.

This analysis involves evaluating each flight specific parameter against the relevant rules to determine its impact on the TOLD parameters. For example, runway length is analyzed against aircraft performance data to determine if it's sufficient for take-off or landing under the current conditions, wind speed and direction are evaluated to calculate their effect on take-off and landing distances, as well as to ensure they're within the aircraft's crosswind limitations, temperature and pressure altitude are analyzed to determine their impact on engine performance and lift generation, which in turn affects take-off and landing speeds and distances, and aircraft weight is checked against maximum take-off and landing weight limits, and its impact on performance is calculated.

Based on this analysis, the engine 210 determines the appropriate TOLD parameters. For instance, if the analysis shows that the runway length is near the minimum required for the current weight and environmental conditions, the engine 210 may calculate a higher V1 speed to allow for a longer acceleration distance. In another example, if crosswind components are high, the engine may adjust the minimum control speeds accordingly. Further, if the temperature is significantly above standard, the engine may calculate increased take-off and landing distances and higher V-speeds to account for decreased aircraft performance.

At block 716, a value of the TOLD parameter is compared with a predefined safety threshold. For example, the engine 210 compares the value of each TOLD parameter with a corresponding predefined safety threshold. These safety thresholds may be stored in a database within the system 208 and may be specific to the aircraft type, operational conditions, and regulatory requirements.

At block 718, on determining the value of the TOLD parameter exceeding the corresponding predefined safety threshold, an alert for the pilot is generated. For example, If the engine 210 determines that any TOLD parameter value exceeds its corresponding safety threshold, it generates an alert for the pilot. This alert may be presented visually on the display device, accompanied by an audible warning, or both. For example, if the calculated take-off distance exceeds 90% of the available runway length (a potential safety threshold), the system would generate an alert to inform the pilot of this critical situation.

At block 720, the TOLD parameters are analyzed with respect to a historical flight data and the flight specific parameters to provide an aircraft configuration suggestion. For example, the engine 210 analyzes the TOLD parameter(s) 424 in conjunction with historical flight data and the current flight specific parameter(s) 422. This analysis is performed to provide a set of aircraft configuration suggestions that may optimize performance and safety for the current take-off or landing operation. Examples of aircraft configuration suggestions include, but may not be limited to, flap setting recommendations, Autobrake setting adjustments, Thrust reverser deployment strategies, Anti-ice system activation recommendations, Anti-skid system engagement advice, and Ground spoiler deployment suggestions.

For instance, based on the analysis of runway conditions (derived from the flight specific parameters) and the calculated landing distance (a TOLD parameter), the engine 210 might suggest a higher autobrake setting to ensure the aircraft may stop within the available runway length.

At block 722, the TOLD parameter along with the configuration suggestion are rendered on the display device to be viewed by the pilot. For example, the engine 210 may present via the display device to the pilot the TOLD parameter(s) 424, configuration suggestions and alerts for effecting the guided control of the aircraft 202 during one of take-off and landing.

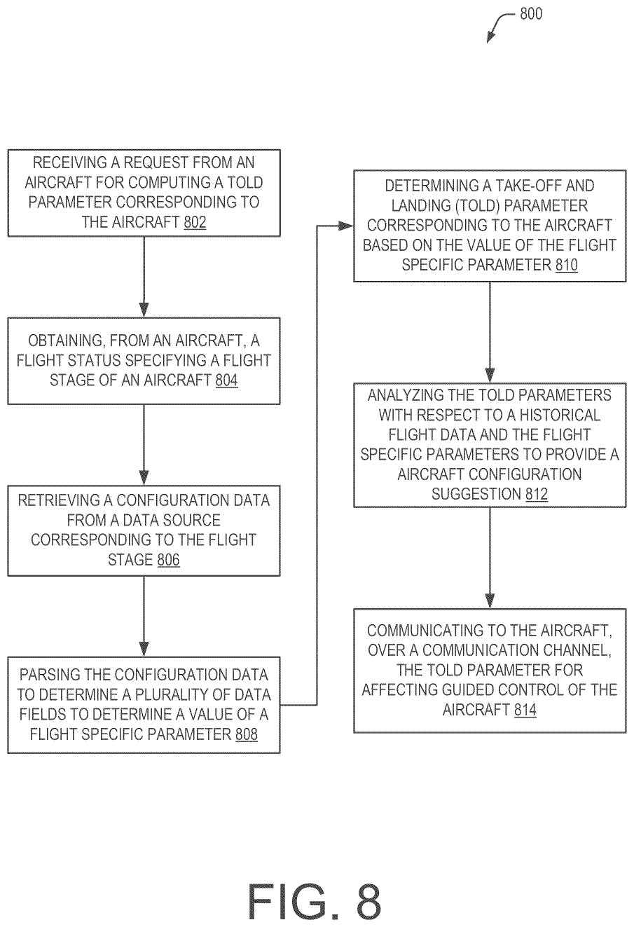

FIG. 8 illustrates a detailed method 800 for determining TOLD parameter for an aircraft by a system implemented within the ground station, as per an example. The order in which the above-mentioned method is described is not intended to be construed as a limitation, and some of the described method blocks may be combined in a different order to implement the method, or an alternative method.

Furthermore, the above-mentioned method 800 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a TOLD computation system, such as system 208, which is implemented within the ground station 204. In an implementation, the method may be performed under an “as a service” delivery model, where the system 208, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 802, a request is received from an aircraft for calculating a TOLD parameter corresponding to the aircraft. For example, as illustrated in FIG. 2, the aircraft 202 may initiate a request through the network 206, which is then received by the system 208. This request may be triggered by various events such as the aircraft entering a new flight stage, encountering changing weather conditions, or preparing for takeoff or landing. The received request typically includes an aircraft identifier and may also contain current flight data or the specific TOLD parameters needed. Upon receipt, the system 208 may log the request, verify the aircraft's identity, and begin the process of gathering relevant data from various sources (as shown in FIG. 3) to calculate the requested TOLD parameters.

At block 804, a flight status specifying a flight stage of the aircraft is obtained. For example, For example, The TOLD computation system, such as system 208, when implemented within the ground station, may obtain or receive flight status from the aircraft 202 through the network 206. In another example, the system 208 which is implemented within the ground station 204 may obtain the flight status from a monitoring device installed within the ground station 204 itself which is monitoring the status of the aircraft 202. This ground-based monitoring device may track the aircraft's position, altitude, speed, and other relevant parameters to determine its current flight stage. Examples of flight stage include, but are not limited to, a pre-flight stage, a take-off stage, a climbing stage, a cruise stage, a descent stage, an approach stage, and a landing stage.

At block 806, a configuration data is retrieved from a data source corresponding to the flight stager. For example, the system 208 may retrieve configuration data from various data source(s) 302 shown in FIG. 3, such as air traffic control 302-1, automatic terminal information service 302-2, Digital-ATIS 302-3, navigational database 302-4, airport moving map 302-5, Aviation Routine Weather Report (METAR) 302-6, terrain database 302-7, or sensor array 302-N. This configuration data may include atmospheric conditions, runway characteristics, aircraft weight, and other relevant flight-specific details for the current flight stage.

At block 808, the configuration data is parsed to determine a plurality of fields to determine a value of a flight specific parameter. For example, the parsing engine 412 within the engine 210, as shown in FIG. 4, may segment the retrieved configuration data into multiple data fields. These fields may include atmospheric pressure, temperature, wind speed and direction, runway length, runway condition, aircraft weight, and fuel load. From these fields, the system extracts values for flight specific parameters such as density altitude, headwind component, or runway friction coefficient.

At block 810, a TOLD parameter is determined based on the value of the flight specific parameter. For example, the engine 210 may use the extracted flight specific parameters to calculate TOLD parameter(s) 424 such as take-off speed, take-off runway length, take-off weight limit, landing speed, landing runway length, or landing weight limit. This computation may involve applying the flight specific parameters to predefined set of rule(s) 426 stored in the system, which may represent aircraft performance models or regulatory requirements.

At block 812, the TOLD parameters are analyzed with respect to a historical flight data the flight specific parameters to provide an aircraft configuration suggestion. For example, the engine 210 analyzes the TOLD parameter(s) 424 in conjunction with historical flight data and the current flight specific parameter(s) 422. This analysis is performed to provide a set of aircraft configuration suggestions that may optimize performance and safety for the current take-off or landing operation. Examples of aircraft configuration suggestions include, but may not be limited to, flap setting recommendations, Autobrake setting adjustments, Thrust reverser deployment strategies, Anti-ice system activation recommendations, Anti-skid system engagement advice, and Ground spoiler deployment suggestions.

For instance, based on the analysis of runway conditions (derived from the flight specific parameters) and the calculated landing distance (a TOLD parameter), the engine 210 might suggest a higher autobrake setting to ensure the aircraft may stop within the available runway length.

At block 814, the TOLD parameter is communicated to the aircraft for effecting the guided control of the aircraft. For example, the determined TOLD parameters may be transmitted from the system 208 to the aircraft 202 through the network 206, as illustrated in FIG. 2. Once received by the aircraft, these parameters may be displayed to the pilot through the integrated avionics interface 304 (FIG. 3), or used directly by the aircraft's flight control systems to adjust take-off or landing configurations, such as flap settings, engine thrust levels, or approach speeds.

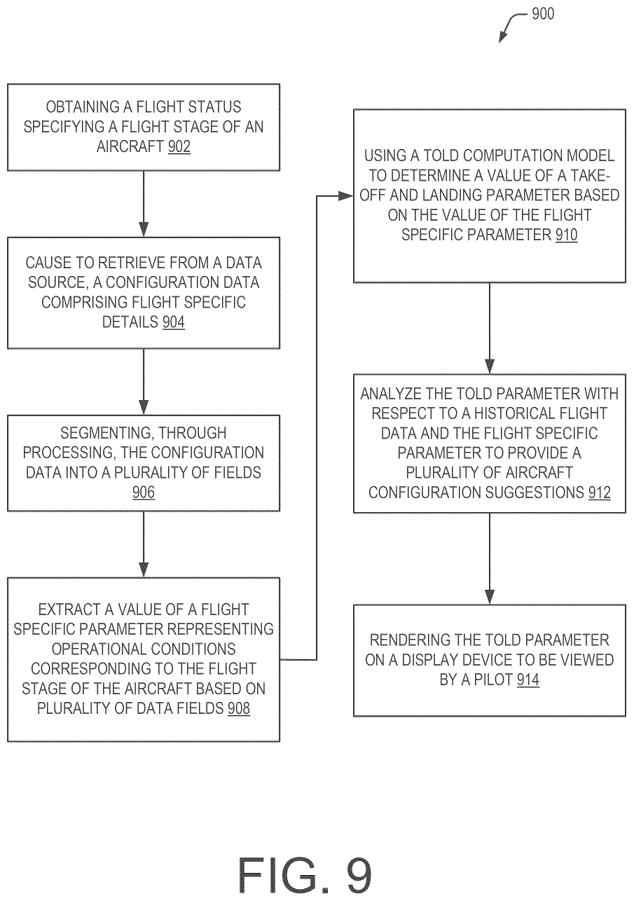

FIG. 9 illustrates another method 900 for determining TOLD parameter for an aircraft using a trained machine learning model, as per an example. The order in which the above-mentioned method is described is not intended to be construed as a limitation, and some of the described method blocks may be combined in a different order to implement the method, or an alternative method.

Furthermore, the above-mentioned method 900 may be implemented in a suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by a TOLD computation system, such as system 208. In an implementation, the method may be performed under an “as a service” delivery model, where the system 208, operated by a provider, receives programmable code. Herein, some examples are also intended to cover non-transitory computer readable medium, for example, digital data storage media, which are computer readable and encode computer-executable instructions, where said instructions perform some or all the steps of the above-mentioned methods.

At block 902, a flight status specifying a flight stage of an aircraft is obtained. For example, the engine 210 of the system 208 may obtain the flight status 418 specifying a flight stage of the aircraft 202. As may be understood, the aircraft 202 may be in any of several possible flight stages, such as pre-flight, take-off, climbing, cruise, descent, approach, or landing. By obtaining the flight status, the engine 210 ascertains the current flight stage of the aircraft 202, which enables it to subsequently retrieve selected or relevant data from various data source(s) 302.

At block 904, a configuration data is retrieved from a data source. For example, the engine 210 may retrieve configuration data 420 comprising flight-specific details corresponding to the flight stage of the aircraft 202. This retrieval process is executed through the integrated avionics interface 304, which serves as a central hub for accessing various data source(s) 302 both onboard the aircraft 202 and from external systems. The configuration data 420 may encompass a wide range of flight-specific details, depending on the current flight stage. For instance, during the pre-flight stage, the engine 210 may retrieve data such as current weather conditions at the departure airport, runway conditions and length, aircraft weight and balance information, fuel load and distribution, and planned route and altitude. Similarly, the engine 210 retrieve configuration data corresponding to various flight stages of the aircraft 202.

At block 906, the configuration data is segmented using processing into a plurality of fields. For example, the parsing engine 412 segments the configuration data 420 into a plurality of data fields. In an example, this segmentation process involves breaking down the retrieved configuration data 420 into distinct, categorized units of information that may be easily processed and analyzed. The parsing engine 412 may employ various techniques to identify and separate different types of data within the configuration information.

At block 908, a value of a flight specific parameter is extracted from the plurality of fields. For example, the parsing engine 412 extracts values of flight specific parameter(s) 422 based on the plurality of data fields. In an example, the flight specific parameter(s) 422 represent operational conditions corresponding to the current flight stage of the aircraft 202. The extraction process involves analyzing the segmented data fields to identify and isolate the relevant values that are crucial for TOLD computations.

At block 910, a TOLD computation model is used to determine a value of a TOLD parameter based on the value of flight specific parameter. For example, the engine 210 may use the model 514 to determine value of a TOLD parameter by inputting the value of the flight specific parameter to the model 514. In an example, the model 514 may incorporate complex algorithms that account for various factors such as aircraft performance characteristics, environmental conditions, and regulatory requirements. For example, the model 514 may take inputs such as aircraft weight, runway length, atmospheric pressure, temperature, and wind conditions to calculate takeoff speeds, required runway distances, or maximum allowable takeoff weights.

At block 912, the TOLD parameter is analyzed with respect to a historical flight data and the flight specific parameter to provide an aircraft configuration suggestion. For example, the engine 210 may analyze the TOLD parameter with respect to a historical flight data and the flight specific parameter to provide a plurality of aircraft configuration suggestions. These aircraft configuration suggestions may comprise one of a flap setting, an autobrake setting, a thrust reverser setting, an anti-ice setting, an anti-skid setting, a ground spoiler setting, or combination thereof.

At block 914, the TOLD parameter is rendered on a display device to be viewed by a pilot. For example, the engine 210 may render the TOLD parameter on a display device to be viewed by a pilot. The TOLD parameter thus determined is for effecting guided control of the aircraft during one of take-off and landing. The TOLD parameter may be one of a take-off speed, a take-off runway length, a take-off weight limit, a landing speed, a landing runway length, a landing weight limit, or combination thereof.

In this way, the present approaches allow using a trained machine learning model to determine the TOLD parameter effecting guided control of the aircraft during one of take-off and landing.

FIG. 10 illustrates a computing environment 1000 implementing a non-transitory computer readable medium for determining take-off and landing (TOLD) parameters for an aircraft. In an example, the computing environment 1000 includes processor(s) 1002 communicatively coupled to a non-transitory computer readable medium 1004 through a communication link 1006. The processor(s) 1002 may have one or more processing resources for fetching and executing computer readable instructions from the non-transitory computer readable medium 1004.

The non-transitory computer readable medium 1004 may be, for example, an internal memory device or an external memory device. In an example implementation, the communication link 1006 may be a network communication link. The processor(s) 1002 and the non-transitory computer readable medium 1004 may also be communicatively coupled to a computing device 1008 over the network.

In an example implementation, the non-transitory computer readable medium 1004 includes a set of computer readable instructions 1010 (referred to as instructions 1010) which may be accessed by the processor(s) 1002 through the communication link 1006. Referring to FIG. 10, in an example, the non-transitory computer readable medium 1004 includes instructions 1010 that cause the processor(s) 1002 to obtain a flight status specifying a flight stage of an aircraft.

The instructions 1010 further cause the processor(s) 1002 to retrieve from a data source, through an integrated avionics interface, a configuration data including flight specific details corresponding to the current flight stage of the aircraft. The data source may include ATC, ATIS, D-ATIS, NOTAM, navigational database, airport moving map, METAR, DOF, terrain database, obstacle database, a plurality of onboard sensors, or combination thereof.

Continuing further, the instructions 1010 cause the processor(s) 1002 to segment, through processing, the configuration data into a plurality of fields, and extract a value of a flight specific parameter from the plurality of fields. In an example, the flight specific parameter represents operational conditions corresponding to the flight stage of the aircraft. Once the flight specific parameter is extracted, the instructions 1010 cause the processor(s) 1002 to use a TOLD computation model to determine value of a TOLD parameter based on the value of the flight specific parameter. The TOLD computation model, as described in conjunction with FIG. 4, is trained based on training flight specific parameters and corresponding training TOLD parameters.

The instructions 1010 then cause the processor(s) 1002 to render the TOLD parameter on a display device to be viewed by a pilot. The TOLD parameter thus determined is for effecting guided control of the aircraft during one of take-off and landing. The TOLD parameter may be one of a take-off speed, a take-off runway length, a take-off weight limit, a landing speed, a landing runway length, a landing weight limit, or combination thereof.

In another example, the instructions 1010 may cause the processor(s) 1002 to analyze the value of the flight specific parameter with respect to a predefined set of rules to determine the TOLD parameter corresponding to the aircraft. Examples of predefined set of rules may include, but are not limited to, safety thresholds for flight parameters, regulatory requirements for take-off and landing operations, aircraft-specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension, brake cooling requirements, tire speed limitations, or combination thereof.

Additionally, the instructions 1010 may cause the processor(s) 1002 to analyze the TOLD parameter with respect to a historical flight data and the flight specific parameter to provide a plurality of aircraft configuration suggestions. These aircraft configuration suggestions may comprise one of a flap setting, an autobrake setting, a thrust reverser setting, an anti-ice setting, an anti-skid setting, a ground spoiler setting, or combination thereof. In this way, the present approaches allow for using a trained machine learning model to determine the TOLD parameter effecting guided control of the aircraft during one of take-off and landing.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain a flight status specifying a flight stage of an aircraft;
cause to retrieve from a data source, through an integrated avionics interface, a configuration data comprising flight-specific details corresponding to the flight stage of the aircraft;
segment, through processing, the configuration data into a plurality of data fields;
extract a value of a flight specific parameter based on plurality of data fields, wherein the flight specific parameter represents operational conditions corresponding to the flight stage of the aircraft;
determine a take-off and landing (TOLD) parameter corresponding to the aircraft based on the value of the flight specific parameter, wherein the TOLD parameter thus determined is for effecting guided control of the aircraft during one of take-off and landing; and
cause to render the TOLD parameter on a display device to be viewed by a pilot.

2. The system of claim 1, wherein the flight stage comprises one of a pre-flight stage, a take-off stage, a climbing stage, a cruise stage, a descent stage, an approach stage, and a landing stage.

3. The system of claim 1, wherein the data source comprises an Air Traffic Control (ATC), an Automatic Terminal Information Service (ATIS), a digital Automatic Terminal Information Service (D-ATIS), a Notice to Air Missions (NOTAM) system, navigation database, an airport moving map, an Aviation Routine Weather Report (METAR), a Digital Obstacle File (DOF) database, terrain database, obstacle database, a plurality of sensors, or combination thereof.

4. The system of claim 1, wherein the TOLD parameter is one of a take-off speed, a take-off runway length, a take-off weight limit, a landing speed, a landing runway length, a landing weight limit, or combination thereof.

5. The system of claim 1, wherein to determine the TOLD parameter, the instructions are executable to:
analyze the value of the flight specific parameter with respect to a predefined set of rules to determine the TOLD parameter corresponding to the aircraft;
wherein the predefined set of rules indicates one of safety thresholds for flight parameters, regulatory requirements for take-off and landing operations, air-craft specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension, brake cooling requirements, tire speed limitations, or combination thereof.

6. The system of claim 1, wherein when the configuration data is obtained from the data source in the form of an audio signal, the instructions are further executable to:
convert the audio signal into a text using an audio transcription technique;
analyze the text to extract the flight specific parameter specifically related to a take-off stage and a landing stage of the aircraft; and
process the flight specific parameter to convert it into a standardized format compatible for determining TOLD parameter.

7. The system of claim 1, wherein the instructions are further executable to:
display the flight specific parameter on the display device to be viewed by the pilot;
receive a pilot confirmation or modification on the displayed flight specific parameter; and
utilize the confirmed or modified flight specific parameter for determining the TOLD parameter.

8. The system of claim 1, wherein the instructions are further executable to:
compare a value of the TOLD parameter with a predefined safety threshold; and
on determining the value of the TOLD parameter exceeding the corresponding safety threshold, generate an alert for the pilot.

9. The system of claim 1, wherein the instructions are executable to:
analyze the TOLD parameter with respect to a historical flight data and the flight specific parameters to provide a plurality of aircraft configuration suggestions:
wherein the aircraft configuration suggestions comprise one of a flap setting, an autobrake setting, a thrust reverser setting, an anti-ice setting, an anti-skid setting, a ground spoiler setting, or combination thereof.

10. A method comprising:
obtaining, from an aircraft, a flight status specifying a flight stage of the aircraft;
retrieving a configuration data from a data source, wherein the configuration data comprises flight-specific details corresponding to the flight stage of the aircraft;
parsing the configuration data to determine a plurality of data fields to determine a value of a flight specific parameter, wherein the flight specific parameter represents operational conditions corresponding to the flight stage of the aircraft;
determine a take-off and landing (TOLD) parameter corresponding to the aircraft based on the value of the flight specific parameter; and
communicating to the aircraft, over a communication channel, the TOLD parameter for effecting guided control of the aircraft during one of take-off and landing.

11. The method of claim 10, wherein the method further comprises:
receiving a request from the aircraft for calculating the TOLD parameter corresponding to the aircraft, wherein the request comprises an aircraft identifier; and
obtaining the flight status corresponding to the aircraft specified by the aircraft identifier, wherein the flight status specifies the flight stage of the aircraft.

12. The method of claim 10, wherein the data source comprises an Air Traffic Control (ATC), an Automatic Terminal Information Service (ATIS), a digital Automatic Terminal Information Service (D-ATIS), a Notice to Air Missions (NOTAM) system, navigation database, an airport moving map, an Aviation Routine Weather Report (METAR), a Digital Obstacle File (DOF) database, terrain database, obstacle database, a plurality of sensors, or combination thereof.

13. The method of claim 10, wherein the TOLD parameter is one of a take-off speed, a take-off runway length, a take-off weight limit, a landing speed, a landing runway length, a landing weight limit, or combination thereof.

14. The method of claim 10, wherein when the configuration data is obtained from the data source as an audio signal, the method further comprises:
converting the audio signal into a text using an audio transcription technique;
analyzing the text to extract the flight specific parameter specifically related to a take-off stage and a landing stage of the aircraft; and
processing the flight specific parameter to convert it into a standardized format compatible for determining TOLD parameter.

15. The method of claim 10, wherein the method comprises:
analyzing the TOLD parameter with respect to a historical flight data and the flight specific parameter to provide a plurality of aircraft configuration suggestions;
wherein the aircraft configuration suggestions comprises one of a flap setting, an autobrake setting, a thrust reverser setting, an anti-ice setting, an anti-skid setting, a ground spoiler setting, or combination thereof; and
communicating the plurality of aircraft configuration suggestions, over the communication channel, to the aircraft for display to a pilot.

16. A non-transitory computer-readable medium comprising instructions, the instructions being executable by a processing resource to:
obtain a flight status specifying a flight stage of an aircraft;
cause to retrieve from a data source, through an integrated avionics interface, a configuration data comprising flight-specific details corresponding to the flight stage of the aircraft;
segment, through processing, the configuration data into a plurality of fields;
extract a value of a flight specific parameter based on plurality of data fields, wherein the flight specific parameter represents operational conditions corresponding to the flight stage of the aircraft; and
use a TOLD computation model to determine a value of a take-off and landing (TOLD) parameter based on the value of the flight specific parameter, wherein the TOLD computation model is trained based on training flight specific parameters and corresponding training take-off and landing (TOLD) parameters;
cause to render the TOLD parameter on a display device to be viewed by a pilot.

17. The non-transitory computer-readable medium of claim 16, wherein the instructions are further executable to:
analyze the value of the flight specific parameter with respect to a predefined set of rules to determine the TOLD parameter corresponding to the aircraft;
wherein the predefined set of rules indicates one of safety thresholds for flight parameters, regulatory requirements for take-off and landing operations, air-craft specific performance limitations and capabilities, environmental condition tolerances, fuel efficiency considerations, noise abatement procedures, obstacle clearance requirements, weight and balance limitations, engine performance characteristics, crosswind and tailwind limitations, minimum and maximum speed constraints, flap and gear extension, brake cooling requirements, tire speed limitations, or combination thereof.

18. The non-transitory computer-readable medium of claim 16, wherein the data source comprises an Air Traffic Control (ATC), an Automatic Terminal Information Service (ATIS), a digital Automatic Terminal Information Service (D-ATIS), a Notice to Air Missions (NOTAM) system, navigation database, an airport moving map, an Aviation Routine Weather Report (METAR), a Digital Obstacle File (DOF) database, terrain database, obstacle database, a plurality of onboard sensors, or combination thereof.

19. The non-transitory computer-readable medium of claim 16, wherein the instructions are further executable to:
analyze the TOLD parameter with respect to a historical flight data and the flight specific parameter to provide a plurality of aircraft configuration suggestions;
wherein the aircraft configuration suggestions comprises one of a flap setting, an autobrake setting, a thrust reverser setting, an anti-ice setting, an anti-skid setting, a ground spoiler setting, or combination thereof.

20. The non-transitory computer-readable medium of claim 16, wherein the TOLD parameter thus determined is for effecting guided control of the aircraft during one of take-off and landing, wherein the TOLD parameter is one of a take-off speed, a take-off runway length, a take-off weight limit, a landing speed, a landing runway length, a landing weight limit, or combination thereof.
